(19) United States
(12) Patent Application Publication
(10) Pub. No.: US 2006/0057960 A1
(43) Pub. Date: Mar. 16, 2006

(54) Systems and methods for remote data storage

(76) Inventor: Bao Q. Tran, San Jose, CA (US)

Correspondence Address: TRAN & ASSOCIATES, 6768 MEADOW VISTA CT., SAN JOSE, CA, 95135, US

(21) Appl. No.: 10/938,708

(22) Filed: Sep. 10, 2004

(51) Int. Cl. H04B 7/00

(52) U.S. Cl. 455/41.2; 455/100

(57) ABSTRACT

A mobile data repository system includes a data storage unit to store content; and a wireless controller coupled to the data storage unit, the wireless transceiver adapted to communicate with a remote processor and store data in the data storage unit.

### BACKGROUND

The present invention relates to wireless data storage devices.

In today's hectic lifestyle, information needs to be available at a person's finger tip. One way to carry information with the user is to store all information on a portable computer such as a laptop computer and to keep the computer within range of the user. However, even though portable computers are lighter than desktop computers, they still weight a few pounds. Handheld devices such as those available from Palm Computing and from Windows CE suppliers are much lighter in weight. However, they are still bulky in the user's pocket. Moreover, when dropped or subjected to physical stress, the display screen, among other components, is prone to failure.

The disclosures of all publications mentioned in the specification and of the publications cited therein are hereby incorporated by reference.

### SUMMARY

A mobile data repository system includes a data storage unit to store content; and a wireless controller coupled to the data storage unit, the wireless transceiver adapted to communicate with a remote processor and store data in the data storage unit.

Advantages of the invention may include one or more of the following. The device allows a user to securely and conveniently carry data with the user. Data is encrypted for ultimate data security. Authentication including password protection and biometric functionalities can be used. The device is highly resistant to vibration, and has a large file backup capacity. It provides a quick and simple interface between PCs, Macs, and handheld computers.

### BRIEF DESCRIPTION OF THE DRAWINGS

FIGS. 1-2 show various wireless flash drive embodiments.

### DESCRIPTION

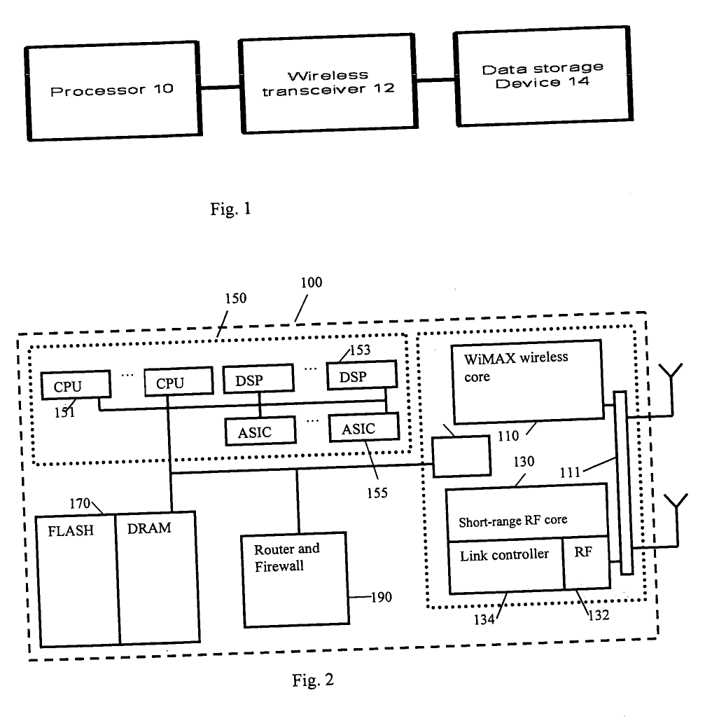

FIG. 1 shows an embodiment having a processor 10 connected to a wireless controller or transceiver 12 and a data storage unit, device or module 14. The processor 10 can be any suitable low power processor such as an ARM or MIPS RISC processor or Texas Instruments' MSP430 microcontroller. The wireless controller 12 can be a Bluetooth device such as the TC2000 from Zeevo of Santa Clara, Calif. or the SiW3500 single chip Bluetooth device from RF Micro Devices. In one example, the data storage module can be 1 GB or 4 GB flash memory available from a number of memory vendors, and the storage capacity is illustrative since larger data storage devices can be used. Alternatively, the data storage device 14 can be a nano data storage device capable of large non-volatile storage capacity.

The TC2000 integrates the T/R switch, antenna filter, and matching network. The first stage of the receiver uses a direct-conversion architecture with high-selectivity and integrated low-pass IF filters. This is followed by an up conversion to a low IF frequency where a single processing path is used to amplify the IF signal to the desired level. This results in a receiver that achieves very high selectivity with low filter complexity. It does not suffer from degraded selectivity at the image frequency and achieves lower overall power consumption. The transmitter is comprised of two primary functional blocks: the IF section and PA/Up converter. The IF section converts the digital signal to analog and performs signal conditioning to ensure the spectral emission requirements are satisfied. The output of the PA is multiplexed with the receiver in the antenna interface block. The analog signal is directly up-converted and amplified. The PLL synthesizer phase locks an integrated voltage controlled oscillator to a 12 MHz external crystal reference. The PLL synthesizer, including loop filter, is fully integrated and no additional external components are required. The baseband modem consists of the demodulator, modulator, receiver and transmitter self-calibration, transmitter/receiver burst timing control, and transmitter burst spectral shaping. The Link Controller executes the baseband protocols and other low-level routines. It includes the FEC encoder/decoder, data whitening, encryption/decryption, and cyclic redundancy check. The Link Controller enables synchronization between two Bluetooth links as well as correlation, frequency hop control, and receiver/transmitter slot timing. The UART is compatible with the 16450 industry standard. Baud rates up to 921.6 K bits/s are supported. Four signals are provided with the UART interface. The Tx and Rx are for data while CTS and RTS are used for flow control. The supported USB is compliant with USB version 1.1 specifications. In addition, sideband signals for host controllers that require Wakeup and Detach signals are also supported.

In another embodiment, the processor 10 can be Texas Instruments MSP430 ultra low power microcontroller and RF-ICs designed to transmit and receive data using the unlicensed ISM (industrial, scientific, and medical) bands specifically designed for short-range halfduplex RF links. The products can cover frequencies from 300 MHz to 950 MHz and support up to 64 Kbps (NRZ). The TI ISM RF and MSP430 ultralow power MCU provide a cost-effective, flexible, complete system acting as a data server.

The processor 10 can execute a mutual authentication scheme instead of one-way authentication. This eliminates “man-in-the-middle attacks” by rogue access points and servers. Additionally, a secure key derivation is used where the original shared secret secure key derivation is used to construct responses to the mutual challenges. It undergoes irreversible one-way hashes that make password-replay attacks impossible. The hash values sent over the wire are useful for one-time use only at the start of the authentication process, and therefore, never after. In addition, by offering a dynamic per-user, per-session key, the system increases the security. Session keys are unique to the users and are not shared among them. By having a session key unique to the user, and by tying it to the network logon, the solution also eliminates vulnerabilities due to stolen or lost client cards or devices. The wireless security also changes the initialization vector (IV) on a per-packet basis so that hackers can find no predetermined sequence to exploit. This capability, coupled with the reduction in possible attack windows, greatly mitigate exposure to hacker attacks due to frequent key rotation. In particular, this makes it difficult to create table-based attacks based on the knowledge of the IVs seen on the wireless network. In yet another embodiment with the 802.11 protocol, the processor 10 provides Wi-Fi Protected Access (WPA) which uses Temporal Key Integrity Protocol (TKIP), generating a new key for every 10 KB of data transmitted over the network. TKIP uses RSA's RC4 to perform the encryption.

The processor 10 allows files and folders to be securely compressed or zipped with a password. The user simply drags and drops the files to compress and decompress. Files are automatically encrypted and password protected. Restricted access of files is achieved with an allocated password. The processor also supports secure email access. The user can email with full privacy—since all communications recorded only on the data storage device 14.

An optional firewall implemented in software can be executed by the processor 10 and is configured to filter data or control signals. The optional firewall may prevent the network device from receiving particular data or commands from the wireless communication devices or prevent the network device from transmitting particular data or commands from the wireless communication devices to the service provider. The optional firewall device provides security for the data storage devices 14 by preventing unknown users from gaining access to sensitive network data.

In another embodiment, the wireless controller 12 transmits signals according to Bluetooth specifications or 802.11 specifications. The controller 12 can use radio-frequency or infrared signals to transmit the content. A display can be driven by the storage device. In a wireless network embodiment, a server wirelessly communicates with one or more thin clients such as processors 10 using 802.1X transmission or Bluetooth transmission or suitable RF transmission.

The architecture is a client-server model. The terms “client” and “server” are used to refer to a computer's general role as a requester of data (the client) or provider of data (the server). In one embodiment, clients and server communicate using a protocol called “HyperText Transfer Protocol” (HTTP) or alternatively FTP. A client opens a connection to a server and initiates a request for data. The system provides web server function using the open source Boa web server program. This allows data to be accessed remotely—from a web browser anywhere in the world. The server delivers the requested data, typically in a standard Hypertext Markup Language (HTML) or XML format, among others. In one embodiment, the system is configured using a Web browser. Web-based configuration requires a late-model browser with Java support and enables users to change network settings, system settings, access permissions, and passwords. The Web interface additionally supports reboots and shutdowns, drive formatting and scan disk, event logging, and firmware upgrades.

In one embodiment, the processor 10 runs Linux operating system. Other software includes a journaled file system, HTTP server, Samba server, DHCP client and UPnP client. UPnP devices are logical containers with specified device types. Each UPnP device can contain any number of logical services, each with its own unique service type. Each service can contain any number of actions (remote procedure calls), each of which can reference any number of service-defined state variables. Logical UPnP devices are passive entities that can be discovered and controlled by a UPnP control point. Devices periodically advertise their presence on the network and can also respond to search requests issued by other nodes on the network. A control point application typically provides the user access to a device's capabilities, invoking actions, and retrieving state information on behalf of the user.

To encourage interoperability between devices that perform similar functions, the UPnP Forum has defined standard device and service types. These device control protocols (DCPs) define required interfaces and capabilities for compliant devices such that no matter what instance of a particular device type you're dealing with you can be sure they will have implemented the same baseline set of capabilities specified by the UPnP Forum. In this way, devices that share a common device type are interoperable with any control point application built for that device type.

When discovered by a control point application such as a UPnP-enabled player, the application will be able to interact with and make use of all of the media devices regardless of prior knowledge or experience with those devices. It is the standardized interfaces that provide a foundation for device interoperability never seen before; where devices from different manufacturers—in wildly different form factors and even designed and built in different countries—can coexist and interoperate with each other.

A DCP defines a device type, with a set of services supported by that device. UPnP devices advertise their presence on the network using the Simple Service Discovery Protocol (SSDP), which extends the HTTP (Hypertext Transfer Protocol) header to provide a simple multicast discovery protocol. A discovery packet contains a link to an XML (extensible markup language) device description document.

The wireless data storage device can be wearable or can be attached to another object.

For example, the wireless flash drive can be embedded inside a watch, a key handle or jewelry.

In yet other embodiments, the wireless flash drive can be a unit that is affixed, embedded or otherwise coupled to a card such as an ID card, a credit/debit card or a smart card. The card can then be housed in a wallet, purse, shoe, clothing, eye-glasses, mouth-guards, retainers or other suitable housing. In non smart-card e-commerce applications, the data storage unit stores encrypted user identification for electronic commerce.

In another embodiment, the data storage unit and the wireless controller are embedded in an electronic card such as an identifier card, a credit/debit card or a smart card. Alternatively, suitable encryption electronics can be embedded in a key, watch, or other suitable portable housing to provide secured transactions. In one embodiment with Bluetooth transceivers, the wireless controller waits for a valid Bluetooth signal from a vending terminal (such as a gas station or a beverage dispenser) and interrogates the vending terminal for a charge authorization.

If the charge is authenticated, the wireless controller allows the charge by the vending terminal to proceed. For example, once a transaction is authorized, the Bluetooth controller sends authorization back to a PC controller at the station, which then turns on the pump. In a low-power embodiment, the wireless controller is manually turned on at the appropriate time to communicate with the vending terminal. A database contains the names of authorized customers and their authorization codes, as well as data about whether they want to charge their transactions or debit them from bank accounts or prepayment plans.

The system can automatically synchronize data stored on the storage device with remotely located data. In one method, a first file transfer program is executed by a remote processor such as a PC that manages file transfers from the data storage unit. A file transfer program on the processor 10 communicates across the wireless communication link (Bluetooth or 802.11) to a PC file transfer program that runs on the personal computer system 150. The PC file transfer program communicates with a PC file system (such as Microsoft Windows) on the personal computer system. To invoke the file transfer system, a user executes the PC file transfer program on the personal computer system. Alternatively, the processor 10 can detect the presence of a Bluetooth or 802.11 signal, for example, and automatically trigger the synchronization process.

FIG. 2 shows a block diagram of a multi-protocol wireless data storage device 100 fabricated on a single silicon integrated chip. In one implementation, the device 100 is an integrated CMOS device with radio frequency (RF) circuits, including a cellular radio core 110, a plurality of short-range wireless transceiver cores 130 that can include Bluetooth cores and 802.11 cores, and a sniffer 111, along side digital circuits, including a reconfigurable processor core 150, a high-density memory array core 170, and a router/firewall 190. The high-density memory array core 170 can include various memory technologies such as flash memory and dynamic random access memory (DRAM), among others, on different portions of the memory array core.

The reconfigurable processor core 150 can include one or more processors 151 such as MIPS processors and/or one or more digital signal processors (DSPs) 153, among others. The reconfigurable processor core 150 has a bank of efficient processors 151 and a bank of DSPs 153 with embedded functions. Through a router 190, the multi-mode wireless data storage device 100 can detect and communicate with any wireless system it encounters at a given frequency. The router 190 performs the switch in real time through an engine that keeps track of the addresses of where the packets are going. The router 190 can send packets in parallel through two or more separate pathways. For example, if a Bluetooth connection is established, the router 190 knows which address it is looking at and will be able to immediately route packets using another connection standard. In doing this operation, the router 190 working with the RF sniffer 111 periodically scans its radio environment (‘ping’) to decide on optimal transmission medium. The router 190 can send some packets in parallel through both the primary and secondary communication channel to make sure some of the packets arrive at their destinations.

The reconfigurable processor core 150 controls the WiMAX radio core 110 and the short-range wireless transceiver cores 130 to provide a seamless dual-mode network integrated circuit that operates with a plurality of distinct and unrelated communications standards and protocols such as Global System for Mobile Communications (GSM), General Packet Radio Service (GPRS), Enhance Data Rates for GSM Evolution (Edge), WiMAX and Bluetooth. The WiMAX core 110 provides wide area network (WAN) access, while the short-range wireless transceiver cores 130 support local area network (LAN) access. The reconfigurable processor core 150 has embedded read-only-memory (ROM) containing software such as IEEE802.11, WiMAX, GSM, GPRS, Edge, and/or Bluetooth protocol software, among others.

For voice reception and speech recognition as a user interface modality, the combined signals are processed by the processor core 150 to form PCM voice samples that are subsequently converted into an analog signal and provided to an external speaker or earphone. Turning now to the short-range wireless transceiver core 130, the short-range wireless transceiver core 130 contains a radio frequency (RF) modem core 132 that communicates with a link controller core 134. The processor core 150 controls the link controller core 134. In one embodiment, the RF modem core 132 has a direct-conversion radio architecture with integrated VCO and frequency synthesizer. The RF-unit 132 includes an RF receiver connected to an analog-digital converter (ADC), which in turn is connected to a modem 116 performing digital modulation, channel filtering, AFC, symbol timing recovery, and bit slicing operations. For transmission, the modem is connected to a digital to analog converter (DAC) that in turn drives an RF transmitter.

The link controller core 134 provides link control function and can be implemented in hardware or in firmware. One embodiment of the core 134 is compliant with the Bluetooth specification and processes Bluetooth packet types. For header creation, the link controller core 134 performs a header error check, scrambles the header to randomize the data and to minimize DC bias, and performs forward error correction (FEC) encoding to reduce the chances of getting corrupted information. The payload is passed through a cyclic redundancy check (CRC), encrypted/scrambled and FEC-encoded. The FEC encoded data is then inserted into the header.

In one embodiment, the system may store a variety of Internet or Ethernet content to be reviewed at a later time by the user. The Internet or Ethernet content may comprise, for example, emails, images, videos, audio samples, Internet Relay Chat (IRC), sale information, consumer reports, stock quotes or news reports on current events, sports or weather. For example, the system may forward news reports to users with a suitable display device. In addition, the system may insert content, such as advertising, in the stream to be reviewed.

The system can communicate with a digital broadcast system such as digital television or digital radio. The system can also communicate with an analog/digital hybrid broadcast system such as the radio broadcast system such as the iBiquity Digital system, described in application Ser. No. 09/802,469, published as U.S. Patent Application 20020095228, the content of which is incorporated by reference. In this application, the system permits consumers to respond to advertisements and purchase goods and services using standard wireless return path. In this case, the user listens to an audio or visual presentation and makes a purchase decision by activating a purchase button on the device or on the receiver. The device queries the broadcast receiver, retrieves the data associated with the content, and stores the data in the data storage device. Subsequently, at a point where data can be forwarded to a fulfillment house, the controller transmits the data to the fulfillment house. In this manner, the system offers creative opportunities for reaching consumers through television or radio—including brand images, product photos, special audio messages and the like. Advertisers have the ability to have their brand messages displayed, not just heard, to captive television or radio audiences. In addition, it allows advertisers the ability to utilize the broadcast medium with much greater frequency, interactivity and creative value—another important aspect of electronic commerce.

In another aspect, the data storage unit is positioned in or on a user. For example, the data storage unit can be embedded under the user's skin for health data collection. In another embodiment, the data storage unit is positioned on teeth. In another embodiment, the data storage unit is ingested by a user in the form of a pill with movable motorized legs. The data storage unit is coupled to a camera and stores images as the pill travels through the user. Wireless patient data, including video images, is transmitted through Bluetooth or 802.11 or WiMAX or other suitable wireless medium. An external computer monitors the information collected by the pill and adjusts the position of the pill by actuating the motor in a closed feedback loop.

In vehicular embodiments, the controller can retrieve audiovisual content from the data storage unit and transmit audiovisual content to a vehicular data storage unit. The data storage unit can store vehicular information. For example, it can have a data structure for storing data from a vehicular sensor that is wirelessly coupled to the controller. The vehicular sensor can include diagnostic sensors. For example, a mileage sensor can transmit data that is stored in the data storage unit as a travel expense record. Alternatively, the vehicular sensor can be a crash sensor and the controller calls an emergency telephone number when the crash sensor is activated. Alternatively, In one embodiment, the vehicle listens for wireless commands from controller. In response to wireless commands sent from the wireless controller to the vehicle, the vehicle can open the door locks, may start the engine of the vehicle, may adjust the heat, and air conditioning, and may control the wipers, headlights, rear defogger, and any other suitable equipment in the vehicle. The wireless key chain device may be preprogrammed by the manufacturer. If desired, the device may be reconfigurable by the user. Other devices that may be controlled by the wireless controller include door locks, lights, garage doors, etc. A wireless key chain device that is used to open the garage door (for example) may be the same device that is used to control the vehicle.

The data storage unit can store a user preference and the controller transmits the user preference to a remote unit for customizing the unit. The unit can be a computer and the user preference is used to customize the computer to the user. In one embodiment, the storage unit stores the user's favorite or frequently accessed URLs. Password information may be encrypted and stored in the storage unit for web sites that require login information.

In another embodiment, the data storage unit stores data to replicate a user's computer so that the user's computer states can be replicated at a remote location for the user. When the user travels to the remote location, the replicated data is used to reconstruct a computer that is identical to the computer whose states have been replicated and stored in the data storage unit. The replication of computer states can be done using various techniques known to those skilled in the art, for example as disclosed in U.S. Pat. No. 6,442,684 to Lee, et al. and entitled “Determining a current machine state of software”, the content of which is incorporated by reference. For example, data stored can describe a set of predetermined functionality for a computer system or for a user. The data may also include information on one or more operating system settings such as printer settings, font settings, network device settings, among others. Moreover, the data may also include information on files such as data files, initialization files, source files, and templates, among others. The data may include system state information on executable files such as .exe files, .dll files and .ocx files as well as machine state such as registry settings, environment variables, support files, and data files at particular points in time.

The system also provides synchronization-database and target-database. The synchronization-database consists of items, each selecting one or more files the user wants to be synchronized and also other properties like a description and sync-method, for example. The sync-method can be directional by copying from the remote data storage device and overriding data on the data storage device 14 or vice versa, or can be time-based so that the latest version is retained in both data storage devices. The target-database holds data about all the computers (targets) that the user wants to be synchronized and for each target information on when the user last exported files and last imported files.

Alternatively, the unit can be a vehicle and the customization can include car seat position adjustment, favorite radio channels, sound settings, and others. For room customization embodiment, the customization can include lighting level adjustment, room temperature adjustment, music volume, radio selection and television selection, among others.

In yet another embodiment, the wireless data storage device can be used to conveniently exchange data through an autonomous agent to simplify the user's life. In one example, the wireless data storage device captures guest's digital business card and searches the web for additional information on the guest and provides the complete information on the guest on demand. In another example, the wireless data storage device automatically collects data from a refrigerator and other household appliances to build a purchase list and upon entry to a supermarket, downloads coupons applicable to items in the purchase list and prompts the user to the necessary items. In yet another example, the entire operating state of a user's primary computer is stored in a file and when the user is away from the primary computer, the user would rent or be allowed access to a computer capable of communicating with the wireless data storage device, the state of the user's primary computer is transmitted to the new computer and enables the new computer to be customized to the state of the user's primary computer so that the user can operate the programs that he or she requires, even though the user is not in front of his or her primary computer.

An energy cell is connected to power the data storage device, the transceiver and the processor. In one embodiment, the cell is atomic powered such as cells available for heart implant devices. In another embodiment, the cell is a fuel cell. In yet another embodiment, an energy cell converts glucose available in the body into ATP into power. Glucose is split and converted to two pyruvate molecules during glycolysis in the cell cytoplasm. During pyruvate conversion, each pyruvate loses one carbon as carbon dioxide, so a total of two carbons are lost per molecule of glucose. During the citric acid cycle, the remaining two carbons from each pyruvate are given off as carbon dioxide. Thus all six carbons of glucose are returned to carbon dioxide. The reactions involving the metabolism of glucose result in the manufacture of high energy compounds, ATP, NADH, FADH2. During electron transport, protons are pumped and through chemiosmotic phosphorylation, NADHs and FADH2s are converted to ATPs. Proton pumps or suitable membrane proteins are used to generate voltage (charge separation) across membranes. Using ATP for power, a proton pump translocates positive charge in the form of hydrogen ions. The voltage and H+ gradient represent a dual energy source to power the data storage device in biological environment such as inside a person.

The techniques described here may be implemented in hardware or software, or a combination of the two. Preferably, the techniques are implemented in computer programs executing on programmable computers that each includes a processor, a storage medium readable by the processor (including volatile and nonvolatile memory and/or storage elements), and suitable input and output devices. Program code is applied to data entered using an input device to perform the functions described and to generate output information. The output information is applied to one or more output devices.

Moreover, each program is preferably implemented in a high level procedural or object-oriented programming language to communicate with a computer system. However, the programs can be implemented in assembly or machine language, if desired. In any case, the language may be a compiled or interpreted language.

Each such computer program is preferably stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

The above-described embodiments of the present invention are merely meant to be illustrative and not limiting. Various changes and modifications may be made without departing from the invention in its broader aspects. The appended claims encompass such changes and modifications within the spirit and scope of the invention.

What is claimed is:

1. A mobile data repository client system, comprising:
a data storage unit to store one or more files;
a wireless transceiver coupled to the data storage unit; and
a processor coupled to the data storage unit and the wireless transceiver to authenticate access to the data storage unit and to wirelessly synchronize one or more files on the data storage unit as a client with a remote data storage unit upon authentication.

2. The system of claim 1, further comprising a wearable housing enclosing at least the data storage unit.

3. The system of claim 1, further comprising one of: a watch housing, a jewelry housing, a credit-card housing, an identifier card housing, a credit/debit card housing and a smart card housing enclosing at least the data storage unit.

4. The system of claim 1, wherein at least the data storage unit is ingested or embedded in a user.

5. The system of claim 1, wherein the wireless transceiver transmits signals according to one of: Bluetooth, 802.11X specifications, WiFi, and WiMax.

6. The system of claim 1, wherein the transceiver transfer data using radio-frequency signals below 11 GHz.

7. The system of claim 1, wherein the controller uses optical signals to transmit content.

8. The system of claim 1, further comprising a display coupled to the storage device.

9. The system of claim 1, wherein the wireless transceiver comprises a digital broadcast receiver and wherein the digital broadcast receiver receives content and advertising data from the digital broadcast, captures a user response to content and advertisement and sends the user response to the processor.

10. The system of claim 9, wherein the receiver receives digital television content or digital radio content.

11. The system of claim 1, further comprising a vehicular sensor wirelessly coupled to the transceiver.

12. The system of claim 11, wherein the vehicular sensor comprises one of a mileage sensor and wherein the data storage unit stores a travel expense record; and a crash sensor and wherein the controller calls an emergency telephone number when the crash sensor is activated.

13. The system of claim 1, wherein the controller transmits lock or unlock command and an authentication code to a vehicle.

14. The system of claim 1, wherein the data storage unit stores a user preference and the transceiver transmits the user preference to a remote unit for customizing the unit.

15. The system of claim 1, wherein the data storage unit stores encrypted user identification for electronic commerce.

16. The system of claim 1, wherein the transceiver handles a plurality of wireless protocols.

17. The system of claim 16, wherein the protocols include one of Bluetooth, WiMAX, 802.11, infrared, GSM, EDGE, and cellular protocols.

18. The system of claim 1, comprising a firewall coupled to the transceiver.

19. The system of claim 1, wherein the processor performs speech recognition as an input modality.

20. The system of claim 1, comprising an energy cell to power the data storage device, the transceiver and the processor and wherein the energy cell converts ATP into power.
